(19) United States
(12) Patent Application Publication
(10) Pub. No.: US 2021/0312535 A1
(43) Pub. Date: Oct. 7, 2021

(54) VIRTUAL APPAREL SOFTWARE SYSTEM AND METHOD

(71) Applicant: Lucas Petar Koren, Mississauga (CA)

(72) Inventor: Lucas Petar Koren, Mississauga (CA)

(21) Appl. No.: 17/348,725

(22) Filed: Jun. 15, 2021

Related U.S. Application Data
(63) Continuation-in-part of application No. 15/947,670, filed on Apr. 6, 2018, now abandoned.

(51) Int. Cl. G06Q 30/06; G06Q 20/08; G06Q 30/04; G06F 16/51; G06T 19/20; G06F 3/0486; G06F 3/0484

(52) U.S. Cl. CPC G06Q 30/0643; G06Q 20/085; G06Q 30/0603; G06Q 30/04; G06T 2219/2021; G06F 16/51; G06T 19/20; G06F 3/0486; G06F 3/04845; G06Q 30/0633

(57) ABSTRACT

A virtual apparel software system and method; the method includes providing a virtual apparel software system including a computing device hosting an application and in communication with a retail supplier via a communication network. At least one catalog is coupled to the computing device and storing therein at least one apparel selection. The retail supplier remotely provides the at least one apparel selection to the at least one catalog. The application may further include a means for generating a 3D replica of a consumer. The 3D replica may be useful for displaying the at least one apparel selection in actual size thereon. The virtual apparel software system and method is used to improve overall consumer experience when online shopping.

### CROSS-REFERENCE TO RELATED APPLICATIONS

This application is a Continuation-in-Part of U.S. Non-provisional Patent application Ser. No. 15/947,670, filed on 6 Apr. 2018, pending, the entire disclosure of which is incorporated by reference.

### BACKGROUND OF THE INVENTION

The following includes information that may be useful in understanding the present disclosure. It is not an admission that any of the information provided is prior art nor material to the presently described or claimed inventions, nor that any publication or document that is specifically or implicitly referenced is prior art.

### TECHNICAL FIELD

The present invention relates generally to the field of software application of existing art and more specifically relates to virtual apparel modeling.

### RELATED ART

Online shopping has become a more prevalent form of consumer shopping for apparel. Apparel can be searched and purchased all from the convenience of a consumer's computer. However, there are ordeals associated with online shopping. When shopping in person, the consumer is able to try apparel on their body in order to find the appropriate size. The consumer is not able to do so when online shopping. Receiving an appropriate size can often take numerous attempts and expend a considerable period of time on the consumer. Further, consumers often have to spend time on multiple online sites when shopping and finding appropriate sizes, causing inconvenience and burden to the consumer. Therefore, a suitable solution is desired.

U.S. Pub. No. 2012/0095589 to Arkady Vapnik relates to a method of detecting the 3D shape of human body and a system of providing Virtual Fitting Room (VFR) service to online retailers over the Internet, in which customer films her/his body moving in front of the camera in a body suit with visible markers. Film is uploaded to the VFR system and processed there by extracting markers coordinates, by tracking markers from frame to frame to achieve automatic registration, and by performing photogrammetric processing of the marker coordinates to obtain and store 3D shape of the customer body. Customer selects an apparel item on an online retailer website, online retailer computer sends a request for fitting service to the VFR system, VFR system retrieves and processes customer digitized 3D body shape and digitized representation of the apparel item, returns virtual images of the customer fitted in the item to online retailer for display of the images to customer.

### SUMMARY OF THE INVENTION

In view of the foregoing disadvantages inherent in the known virtual apparel modeling art, the present disclosure provides a novel virtual apparel software system and method. The general purpose of the present disclosure, which will be described subsequently in greater detail, is to provide an effective and efficient virtual apparel software system and method.

A method of using a virtual apparel software system is disclosed herein. The method of using the virtual apparel software system includes providing the virtual apparel software system, comprising a computing device hosting an application and in communication with a retail supplier via a communication network, and at least one catalog coupled to the computing device and storing therein at least one apparel selection. The retail supplier may remotely provide the at least one apparel selection to the at least one catalog. The method may further include registering a profile associated with a consumer; receiving a series of prompts for body-dimensions of the consumer; generating a 3D replica of the consumer; selecting the at least one apparel selection from the at least one catalog; adjusting a size associated with the at least one apparel selection such that it correlates to the body-dimensions of the consumer; displaying the at least one apparel selection on the 3D replica; purchasing the at least one apparel selection; and sending a payment-invoice for the purchase of the at least one apparel selection to the retail supplier such that the retail supplier receives a percentage of sales associated with the purchase of the at least one apparel selection.

### BRIEF DESCRIPTION OF THE DRAWINGS

The figures which accompany the written portion of this specification illustrate embodiments and methods of use for the present disclosure, a virtual apparel software system and method, constructed and operative according to the teachings of the present disclosure.

FIG. 1 is a flow diagram illustrating a method of using a virtual apparel software system, according to an embodiment of the present disclosure.

FIG. 2 is a perspective view of the virtual apparel software system during an ‘in-use’ condition, according to an embodiment of the disclosure.

FIG. 3 is a flow diagram of the virtual apparel software system of FIG. 1, according to an embodiment of the present disclosure.

FIG. 4 is a perceptive view of the virtual apparel software system of FIG. 1, according to an embodiment of the present disclosure.

FIG. 5 is a perspective view of the virtual apparel software system of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a virtual apparel modeling and more particularly to a virtual apparel software system and method as used to improve overall consumer experience when online shopping.

Generally, the present invention may effectively ensure products will ‘fit’ the consumer when it arrives at their door and allow them to create looks and pick styles. The software application may make an online apparel purchase a confident one for the consumer. Apparel retailers can partner with the application in order to occur a decrease in returns expenses and an increase in payment-invoices as a result. Apparel may include clothing, jewelry, shoes, and the like. Further, the software application can act as an online gathering place or mall for consumers to find and try on apparel virtually.

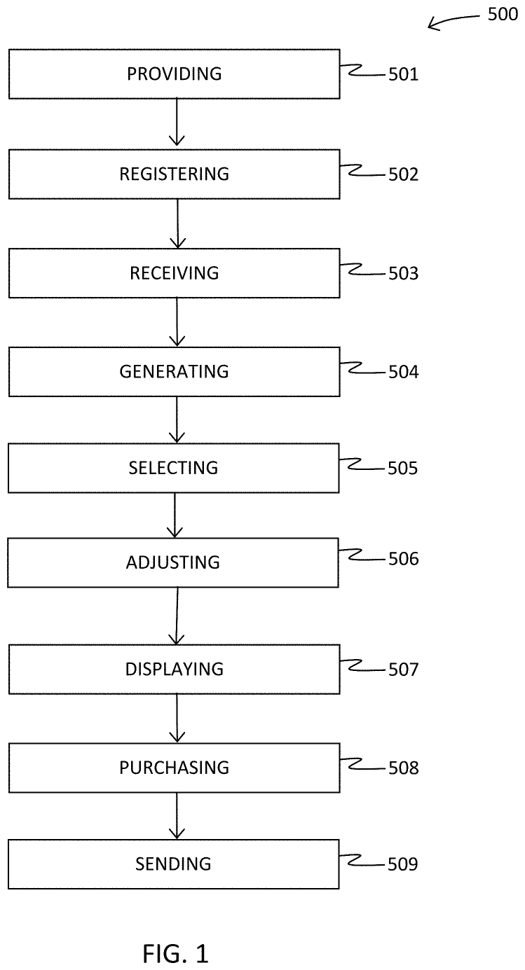

Referring now more specifically to the drawings by numerals of reference, there is shown in FIGS. 1-5, various views and flowcharts of a virtual apparel software system and method 500.

FIG. 1 shows a flow diagram of a method of using a virtual apparel software system 500, according to an embodiment of the present disclosure. In particular, the method of using the virtual apparel software system 500 may include one or more components or features of a virtual apparel software system 100. Here, the method of using the virtual apparel software system 500 may be beneficial for use by a consumer 40 to provide virtual apparel modeling of the consumer 40 in a 3D replica 120. As illustrated, the method of using the virtual apparel software system 500 may include step one 501, providing the virtual apparel software system 100, comprising: a computing device 110 hosting an application 115 and in communication with a retail supplier 113 via a communication network 124, and at least one catalog 114 coupled to the computing device 110 and storing therein at least one apparel selection 116. The retail supplier 113 may remotely provide the at least one apparel selection 116 to the at least one catalog 114.

The method 500 may further include step two 502, using the computing device 110 or using a remote computing device 111 to register a profile associated with the consumer 40; step three 503, receiving a series of prompts 118 for body-dimensions of the consumer 40; step four 504, generating the 3D replica 120 of the consumer 40; step five 505, selecting the at least one apparel selection 116 from the at least one catalog 114; step six 506, adjusting a size associated with the at least one apparel selection 116 such that it correlates to the body-dimensions of the consumer 40; step seven 507, displaying the at least one apparel selection 116 on the 3D replica 120; step eight 508, purchasing the at least one apparel selection 116; and step nine 509, sending a payment-invoice for the purchase of the at least one apparel selection 116 to the retail supplier 113 such that the retail supplier 113 receives a percentage of sales associated with the purchase of the at least one apparel selection 116. In some versions, registering a profile includes registering a profile associated with the remote consumer. In some versions, customizing the 3D replica or generating the 3D replica includes using remote data. In some versions, customizing the 3D replica or generating the three to replica includes using remote data about physical characteristics of the consumer or remotes consumer.

In addition, the method 500 may include the steps of customizing the 3D replica 120. Customizing may include changing a plurality of physical characteristics associated with the 3D replica 120. Physical characteristics refer to hair, skin, tattoos, or the like. This may enable the 3D replica 120 to become more personal to the consumer 40. Furthermore, the profile may include a functional consumer-image for additional personalization. The consumer-image can be displayable on the 3D replica 120. The 3D replica 120 may be understood as a computerized representation of the consumer 40. In some versions, the body dimensions data is received from a remote consumer.

The method 500 may further include adding other consumer(s) to a contact-list 126 such that the other consumer(s) are easily accessible via the application 115. The consumer 40 may be able to purchase the at least one apparel selection 116 for the other consumer(s) on the contact-list 126 as a gift. The size of the at least one apparel selection 116 may automatically adjust to the body-dimensions associated with the other consumer(s) on the contact-list 126. However, the body-dimensions of the other consumer(s) may not be viewable or made public to the consumer 40 when purchasing the gift.

The present invention may be useful for partnering retailer suppliers 113 on a single online platform. The method 500 may include licensing the application 115 to the retail suppliers 113 to provide access to the at least one catalog 114, such that the at least one apparel selection 116 is made available in one place for convenience to the consumer 40. The application 115 can act as a virtual mall to benefit the consumer 40 and their online shopping experience. The consumer 40 may have virtually unlimited and free access to the application 115 with the method of using the virtual apparel software system 500.

It should also be noted that the steps described in the method of use 500 can be carried out in many different orders according to consumer 40 preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the virtual apparel software system 100 (e.g., different step orders within above-mentioned list, elimination or addition of certain steps, including or excluding certain steps, etc.), are taught herein.

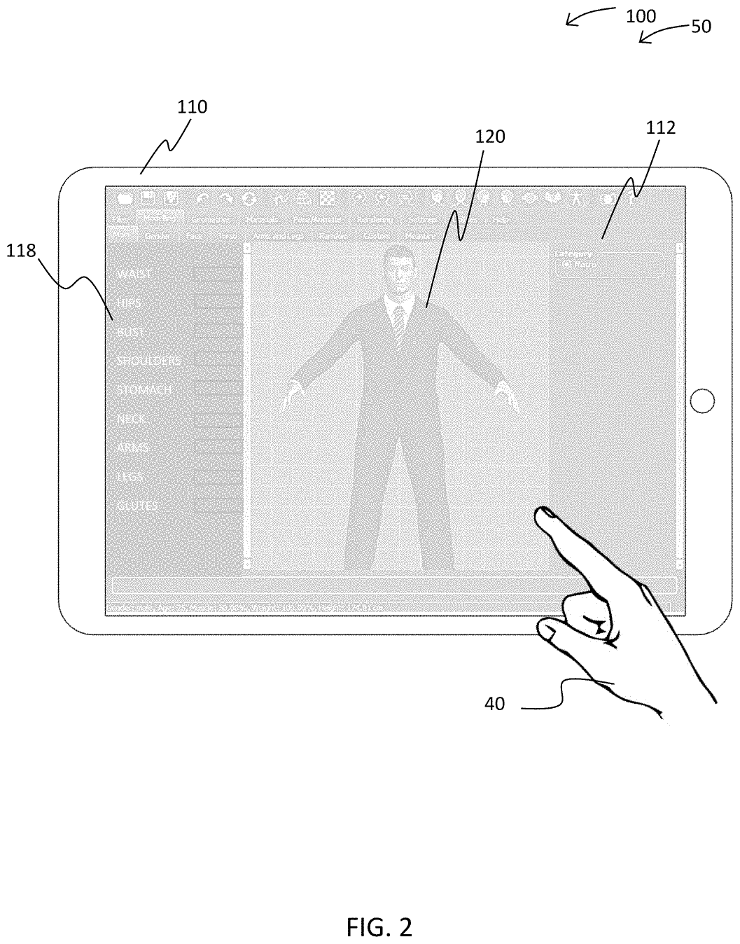

FIG. 2 shows the virtual apparel software system 100 of FIG. 1 during an in-use condition 50, according to an embodiment of the present disclosure. As above, the virtual apparel software system 100 may include the computing device 110 hosting the application 115 and in communication with the retail supplier 113 via the communication network 124, and the at least one catalog 114 may be coupled to the computing device 110 and storing therein the at least one apparel selection 116. The retail supplier 113 may remotely provide the at least one apparel selection 116 to the at least one catalog 114.

An interface 112 may be coupled to the computing device 110 enabling the consumer 40 to interact with the application 115. The interface 112 is selected from a group consisting of touch capacitive displays, keyboards, buttons, switches, and the like. In some versions, the interface 112 operates on a second computing device remote from the computing device 110.

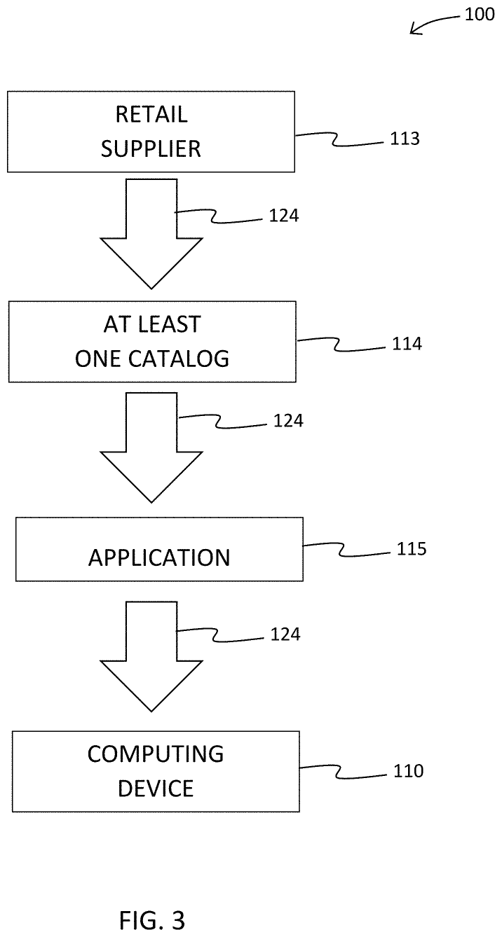

Referring now to FIG. 3 showing a flow diagram view of the virtual apparel software system 100 of FIG. 1, according to an embodiment of the present disclosure. The communication network 124 may be wireless. The retail supplier 113 may provide the at least one apparel selection 116 to the at least one catalog 114 on the application 115 for viewing with the computing device 110 wirelessly. The flow diagram details these steps. Those with ordinary skill in the art will now appreciate that upon reading this specification and by their understanding the art of applications and communication network 124s as described herein, methods of using the application with communication network 124 will be understood by those knowledgeable in such art. In some versions, there is more than one retail supplier 113.

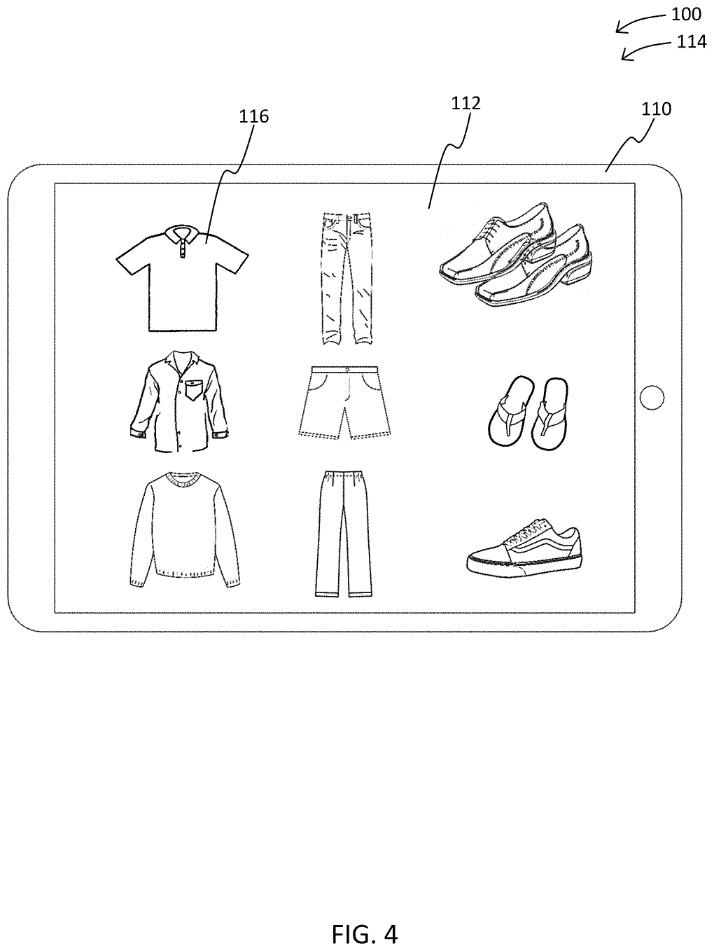

FIG. 4 is a perspective view of the virtual apparel software system 100 of FIG. 1, according to an embodiment of the present disclosure. A processor may be coupled to the computing device 110 for enabling the at least one apparel selection 116 to be displayed on the 3D replica 120 in the size. The size may be a computer representation of the appropriate size of apparel for the consumer 40 according to inputted body-dimensions. The processor may enable the at least one apparel selection 116 to be converted from a 2D viewing on the at least one catalog 114 to a 3D viewing on the 3D replica 120 and configured to allow the consumer 40 to visualize how the at least one apparel selection 116 would look in the size.

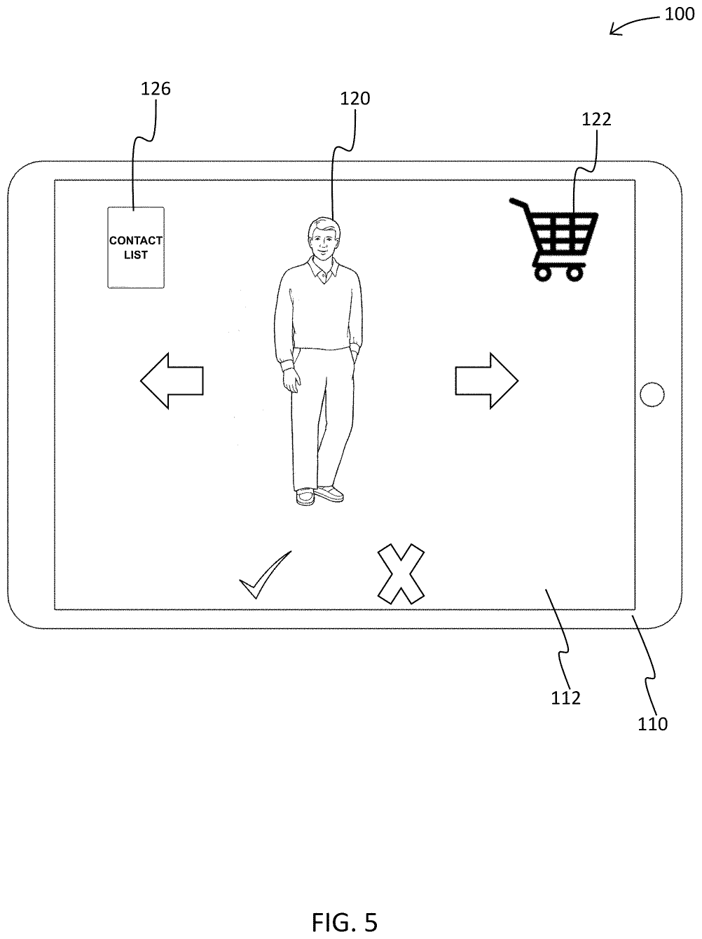

Referring now to FIG. 5 a perspective view of the virtual apparel software system 100 of FIG. 1, according to an embodiment of the present disclosure. As stated above, the interface 112 may be coupled to the computing device 110 enabling the consumer 40 to interact with the application 115. The body-dimensions may be inputted via the series of prompts 118 on the interface 112. The series of prompts 118 for body-dimensions may include a combination of waist, hips, bust, shoulders, stomach, neck, arms, legs, and glutes. The series of prompts 118 for body-dimensions may not be limited to those listed and can be adjusted according to improvements or modifications of the application 115. The interface 112 may further enable a drag-and-drop of the at least one apparel selection 116 from the at least one catalog 114 to the 3D replica 120, such that the at least one apparel selection 116 is displayable on the 3D replica 120. Further, the interface 112 may include a shopping-cart 122, or a means for accessing the shopping-cart 122 associated with the application 115. The shopping-cart 122 may enable purchases of the at least one apparel selection 116 through the application 115. The contact-list 126 may further be accessible on the interface 112.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

1. A method comprising:
providing
a computing device hosting an application and in communication with a retail supplier via a communication network;
a catalog coupled to the computing device and storing an apparel selection;
wherein the retail supplier communicates the selection to the catalog;
registering a profile associated with a remote consumer;
receiving a series of body-dimension data from a remote consumer;
generating a 3D replica of the consumer;
selecting the selection from the catalog;
adjusting a size associated with the selection such that it correlates to the body-dimensions of the consumer;
displaying the selection on the 3D replica;
selling the selection to the consumer; and
sending an invoice for the selection to the retail supplier;
and
sending a payment representing a percentage of the sale of the selection.

2. The method of claim 1, further comprising customizing the 3D replica using remote data.

3. The method of claim 2, wherein the remote data includes physical characteristic data from the consumer.

4. The method of claim 3, wherein the body-dimension data included a combination of waist, hips, bust, shoulders, stomach, neck, arms, legs, and glutes dimension data.

5. The method of claim 4, wherein the profile stores a functional consumer-image comprising body-dimension data and physical characteristics data.

6. The method of claim 5, further comprising sending 3D data to the consumer and causing a remote computer to display the 3D replica.

7. The method of claim 6, wherein the application generates a user interface for the application.

8. The method of claim 7, wherein the body-dimensions are using the interface.

9. The method of claim 8, wherein the interface enables a drag-and-drop of the selection from the catalog to the 3D replica.

10. The method of claim 9, wherein the interface includes a shopping-cart.

11. The method of claim 10, wherein the shopping-cart enables purchases of selection through the application.

12. The method of claim 11, further comprising a processor coupled to the computing device for calculating the 3D replica data and communicating the data to the computing device.

13. The method of claim 12, wherein the processor converts the selection from a 2D view on the catalog to a 3D view on the 3D replica in an accurate size.

14. The method of claim 13, wherein the communication network is wireless.

15. The method of claim 14 wherein the measurements are measured with a tape measure located local to the consumer.
